(19) United States
(12) Patent Application Publication
(10) Pub. No.: US 2025/0119244 A1
(43) Pub. Date: Apr. 10, 2025

(54) ONE SHOT HYBRID AUTOMATIC REPEAT REQUEST FEEDBACK REPORTING

(71) Applicant: Lenovo (Singapore) Pte. Ltd., New Tech Park (SG)

(72) Inventors: Karthikeyan Ganesan, Kronberg im Taunus (DE); Alexander Golitschek Edler von Elbwart, Darmstadt (DE); Joachim Löhr, Wiesbaden (DE); Prateek Basu Mallick, Dreieich (DE); Vijay Nangia, Woodridge, IL (US); Ravi Kuchibhotla, Chicago, IL (US)

(21) Appl. No.: 18/833,292

(22) PCT Filed: Jan. 26, 2023
(86) PCT No.: PCT/IB2023/050691

§ 371 Date: Jul. 25, 2024

Related U.S. Application Data
(60) Provisional application No. 63/303,327, filed on Jan. 26, 2022.

(51) Int. Cl. H04L 1/1867; H04W 72/25; H04W 76/40

(52) U.S. Cl. CPC H04L 1/1896; H04W 72/25; H04W 76/40

(57) ABSTRACT

Apparatuses, methods, and systems are disclosed for one shot hybrid automatic repeat request feedback reporting. One method includes transmitting, from a user equipment (“UE”), a configuration for a one shot hybrid automatic repeat request (“HARQ”) feedback request to at least one receiver. The method includes configuring one shot HARQ feedback including one or more of a one shot HARQ feedback request bit field in sidelink control information (“SCI’), a destination identifier (“ID”), a cast type indicator, or a bitmap containing HARQ processes. The method includes receiving the one shot HARQ feedback report associated with a subset of HARQ processes of a plurality of HARQ processes and based at least in part on a cast type and a groupcast HARQ feedback.

### FIELD

The subject matter disclosed herein relates generally to wireless communications and more particularly relates to one shot hybrid automatic repeat request (“HARQ”) feedback reporting.

### BACKGROUND

In certain wireless communications networks, HARQ feedback may be transmitted. In such networks there may be a limited amount of bandwidth for communicating HARQ feedback.

### BRIEF SUMMARY

Methods for one shot HARQ feedback reporting are disclosed. Apparatuses and systems also perform the functions of the methods. One embodiment of a method includes transmitting, from a user equipment (“UE”), a configuration for a one shot HARQ feedback request to at least one receiver. In some embodiments, the method includes configuring one shot HARQ feedback including one or more of a one shot HARQ feedback request bit field in sidelink control information (“SCI”), a destination identifier (“ID”), a cast type indicator, or a bitmap containing HARQ processes. In certain embodiments, the method includes receiving the one shot HARQ feedback report associated with a subset of HARQ processes of a plurality of HARQ processes and based at least in part on a cast type and a groupcast HARQ feedback.

One apparatus for one shot HARQ feedback reporting includes a processor; and a memory coupled to the processor, the processor configured to cause the apparatus to: transmit a configuration for a one shot HARQ feedback request; configure one shot HARQ feedback including one or more of a one shot HARQ feedback request bit field in SCI, a destination ID, a cast type indicator, or a bitmap indicating HARQ processes; and receive the one shot HARQ feedback report associated with a subset of HARQ processes of a plurality of HARQ processes and based at least in part on a cast type and a groupcast HARQ feedback.

Another embodiment of a method for one shot HARQ feedback reporting includes transmitting, from a network device to a UE, a DCI comprising a trigger to request one shot HARQ feedback. In some embodiments, the method includes configuring one shot HARQ feedback reporting for a plurality of SL carriers. In certain embodiments, the method includes receiving a one shot HARQ feedback request from the UE.

Another apparatus for one shot HARQ feedback reporting includes a processor; and a memory coupled to the processor, the processor configured to cause the apparatus to: transmit, to a UE, a DCI comprising a trigger to request one shot HARQ feedback; configure one shot HARQ feedback reporting for a plurality of SL carriers; and receive a one shot HARQ feedback request from the UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for one shot HARQ feedback reporting;

FIG. 2 is a schematic block diagram illustrating one embodiment of an apparatus that may be used for one shot HARQ feedback reporting;

FIG. 3 is a schematic block diagram illustrating one embodiment of an apparatus that may be used for one shot HARQ feedback reporting;

FIG. 4 is a schematic block diagram illustrating one embodiment of a system showing active HARQ processes between UEs;

FIG. 5 is a schematic block diagram illustrating one embodiment of a system for physical sidelink feedback channel (“PSFCH”) enhancement for reporting one shot HARQ feedback;

FIG. 6 is a flow chart diagram illustrating one embodiment of a method for one shot HARQ feedback reporting; and

FIG. 7 is a flow chart diagram illustrating another embodiment of a method for one shot HARQ feedback reporting.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

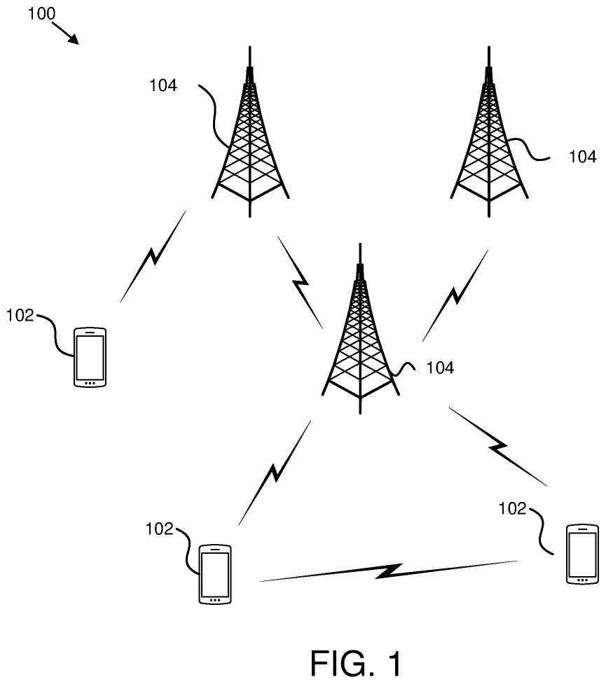

FIG. 1 depicts an embodiment of a wireless communication system 100 for one shot HARQ feedback reporting. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink (“SL”) communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may transmit a configuration for a one shot HARQ feedback request to at least one receiver (e.g., a network unit 104). In some embodiments, the remote unit 102 may configure one shot HARQ feedback containing a one shot HARQ feedback request bit field in SCI (e.g., the one shot HARQ feedback request bit field indicates whether a one shot HARQ feedback request is being made), at least one destination ID, a cast type indicator (e.g., an indicator that indicates a cast type), a bitmap containing HARQ processes (e.g., the bitmap indicates one or more HARQ processes), or some combination thereof. In certain embodiments, the remote unit 102 may receive the one shot HARQ feedback report from at least one destination (e.g., a network unit 104 or one or more other remote units 102) based on a subset of HARQ processes of a plurality of HARQ processes, and there may be a corresponding procedure for handling the one shot HARQ feedback report by considering reception from different cast types and groupcast HARQ feedback options. Accordingly, the remote unit 102 may be used for one shot HARQ feedback reporting.

In some embodiments, a remote unit 102 may transmit, from a UE, a configuration for a one shot HARQ feedback request to at least one receiver. In some embodiments, the remote unit 102 may configure one shot HARQ feedback including one or more of a one shot HARQ feedback request bit field in SCI, a destination ID, a cast type indicator, or a bitmap containing HARQ processes. In certain embodiments, the remote unit 102 may receive the one shot HARQ feedback report associated with a subset of HARQ processes of a plurality of HARQ processes and based at least in part on a cast type and a groupcast HARQ feedback. Accordingly, the remote unit 102 may be used for one shot HARQ feedback reporting.

In certain embodiments, a network unit 104 may transmit a trigger to request one shot HARQ feedback from a remote unit 102 (e.g., a transmitter UE). In some embodiments, the network unit 104 may transmit the trigger using DCI. In some embodiments, the network unit 104 may configure reporting of one shot HARQ feedback reporting over a plurality of SL carriers. In certain embodiments, the network unit 104 may receive a one shot HARQ feedback request from the remote unit 102 (e.g., the transmitter UE) corresponding to all SL HARQ processes considering the plurality of SL carriers. Accordingly, the network unit 104 may be used for one shot HARQ feedback reporting.

In various embodiments, a network unit 104 may transmit a trigger to request one shot HARQ feedback from a remote unit 102 (e.g., a transmitter UE). In some embodiments, the network unit 104 may transmit, to a UE, a DCI comprising a trigger to request one shot HARQ feedback. In some embodiments, the network unit 104 may configure one shot HARQ feedback reporting for a plurality of SL carriers. In certain embodiments, the remote unit 104 may receive a one shot HARQ feedback request from the UE. Accordingly, the network unit 104 may be used for one shot HARQ feedback reporting.

In some embodiments, as part of a new radio (“NR”) unlicensed (“U”) (“NR-U”) one shot HARQ feedback, HARQ feedback corresponds to a snapshot of a HARQ acknowledgement (“ACK”) (“HARQ-ACK”) report of all HARQ processes transmitted using a physical uplink control channel (“PUCCH”) or a physical uplink shared channel (“PUSCH”) if downlink control information (“DCI”) format 1_1 contains one bit to request a transmission of one shot HARQ feedback. In various embodiments, a reduced HARQ-ACK codebook may be transmitted. In certain embodiments, a reduced HARQ-ACK codebook is a HARQ-ACK requested for a subset of HARQ processes from a plurality of HARQ processes.

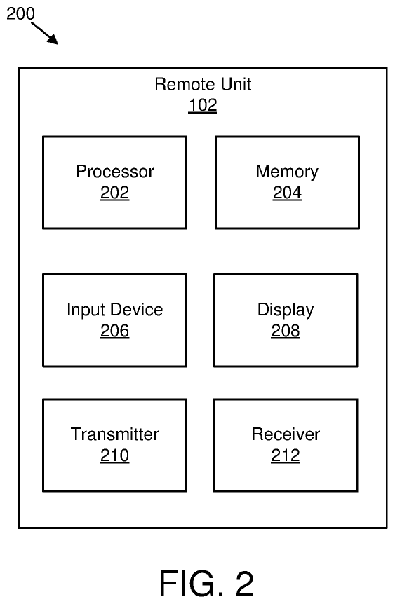

FIG. 2 depicts one embodiment of an apparatus 200 that may be used for one shot HARQ feedback reporting. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the transmitter 210 transmits a configuration for a one shot HARQ feedback request to at least one receiver (e.g., a remote unit 102, or a network unit 104). In various embodiments, the processor 202 configures one shot HARQ feedback containing a one shot HARQ feedback request bit field in SCI, at least one destination ID, a caste type indicator, a bitmap containing HARQ processes, or some combination thereof. In certain embodiments, the receiver 212 receives the one shot HARQ feedback report from at least one destination based on a subset of HARQ processes of a plurality of HARQ processes, and there may be a procedure for handling the one shot HARQ feedback report by considering reception from different cast types and groupcast HARQ feedback options. In some embodiments, the processor 202 is configured to cause the apparatus 200 to: transmit a configuration for a one shot HARQ feedback request; configure one shot HARQ feedback including one or more of a one shot HARQ feedback request bit field in SCI, a destination ID, a cast type indicator, or a bitmap indicating HARQ processes; and receive the one shot HARQ feedback report associated with a subset of HARQ processes of a plurality of HARQ processes and based at least in part on a cast type and a groupcast HARQ feedback.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

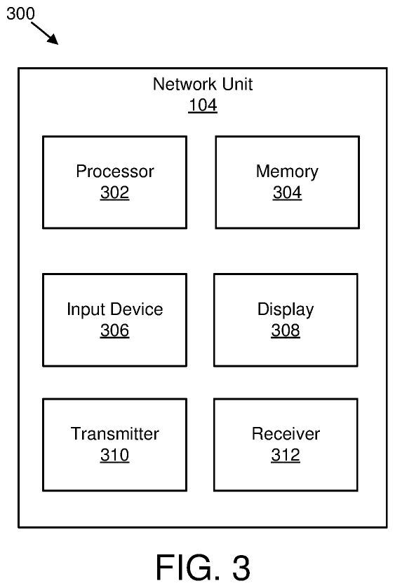

FIG. 3 depicts one embodiment of an apparatus 300 that may be used for one shot HARQ feedback reporting. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 transmits a trigger to request one shot HARQ feedback from a remote unit (e.g., a transmitter UE), wherein the trigger is transmitted using DCI. In various embodiments, the processor 302 configures reporting of one shot HARQ feedback reporting over a plurality of SL carriers. Put another way, the processor 302 may configure the apparatus 300 to receive or transmit a one shot HARQ feedback report over multiple SL carriers. In certain embodiments, the receiver 312 receives a one shot HARQ feedback request, from the remote unit (e.g., the transmitter UE), corresponding to all SL HARQ processes based on the plurality of SL carriers. In some embodiments, the processor 302 is configured to cause the apparatus 300 to: transmit, to a UE, a DCI comprising a trigger to request one shot HARQ feedback; configure one shot HARQ feedback reporting for a plurality of SL carriers; and receive a one shot HARQ feedback request from the UE.

In certain embodiments, a one shot HARQ feedback procedure for SL unlicensed operation may be defined.

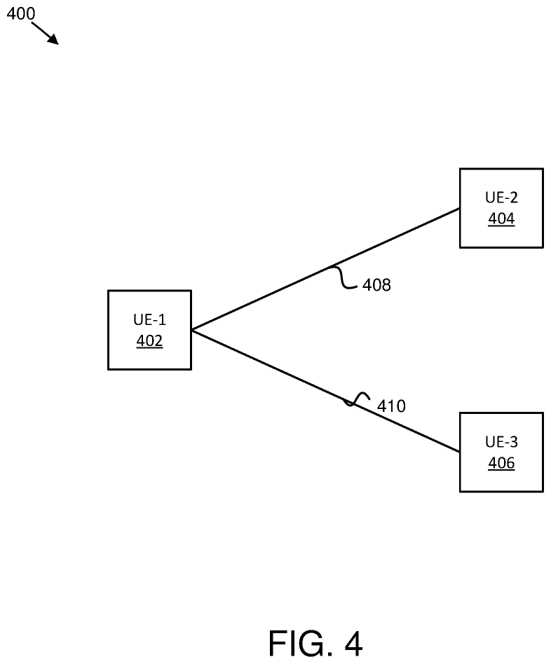

In some embodiments, in SL, one shot HARQ feedback may be associated with respect to destinations and/or cast types, and there may be a threshold number of HARQ processes between a source-destination pair of UEs as shown in FIG. 4. In various embodiments, there may be a transmission of a SL one shot HARQ feedback request by associating it with source-destination identifiers (“IDs”) and/or cast types such as unicast, groupcast, and broadcast, and there may be reporting of one shot HARQ feedback considering different cast types, blind retransmissions, and so forth.

FIG. 4 is a schematic block diagram illustrating one embodiment of a system 400 showing active HARQ processes between UEs. The system 400 includes a first UE 402 (UE-1), a second UE 404 (UE-2), and a third UE 406 (UE-3). For a communication link 408 between the first UE 402 and the second UE 404, there may be HARQ processes 1 and 5. Moreover, for a communication link 410 between the first UE 402 and the third UE 406, there may be HARQ processes 2 and 6.

In certain embodiments, for one-shot HARQ feedback: a new data indicator (“NDI”) can be configured to be part of one-shot HARQ feedback. If NDI is configured: 1) the latest NDI value detected by a UE (e.g., the first UE 402, the second UE 404, or the third UE 406, or any combination thereof) is reported along with HARQ-ACK for the corresponding HARQ process ID—the UE assumes NDI=0 if there is no prior NDI value for the HARQ process; and/or 2) NDI is included for each transport block (“TB”). If NDI is not configured: 1) NDI value is not reported along with HARQ-ACK for the corresponding PDSCH; and/or 2) the UE is expected to reset HARQ-ACK state (as DTX or NACK) for a HARQ process ID once ACK is reported for the same HARQ process ID in the previous feedback. In some embodiments, code block group (“CBG”)-based HARQ-ACK or TB-based HARQ-ACK can be configured to be part of the one-shot HARQ feedback for the component carriers (“CCs”) configured with CBG. It should be noted that for any HARQ ID that is scheduled after the last determined PDSCH for which ACK/NACK decoding result is reported, the UE does not consider this PDSCH for one-shot HARQ codebook composition.

In various embodiments, in a one-shot codebook, the NDI follows the HARQ-ACK information for each TB. In certain embodiments, in the one-shot codebook, the ordering of information for HARQ-ACK and NDI is as follows: 1) CBG index; 2) TB index; 3) HARQ process ID; and/or 4) serving cell index.

In some embodiments, for a DCI requesting one-shot HARQ-ACK feedback without scheduling PDSCH, reuse the minimum processing latency for semi-persistence scheduled release DCI. In various embodiments, an intended behavior according to NR-U agreements is commonly understood: 1) Type-3 CB can be triggered and reported when no DCI indicated a NNK1 value; 2) Type-3 CB can report HARQ-ACK information for a PDSCH scheduled with NNK1 when UE is configured with type-1 CB; and/or 3) Type-1 CB cannot report HARQ-ACK information for a PDSCH scheduled with NNK1.

In certain embodiments, if a UE is provided pdsch-HARQ-ACK-OneShotFeedback, the UE determines õ₀^{ACK}, õ₁^{ACK}, . . . , õ_{AXK-1}^{ACK} HARQ-ACK information bits, for a total number of O_{ACK} HARQ-ACK information bits, of a Type-3 HARQ-ACK codebook according to the following procedure, with the following: 1) set N_{cells}^{DL} to the number of configured serving cells; 2) set N_{HARQ,c}^{DL} to the value of nrofHARQ-ProcessesForPDSCH for serving cell c, if provided; else, set N_{HARQ,c}^{DL}=8; 3) set N_{TB,c}^{DL} to the value of maxNrofCodeWordsScheduledByDCI for serving cell c if harq-ACK-SpatialBundling PUCCH is provided and NDI_{HARQ}=0, or if harq-ACK-SpatialBundlingPUCCH is not provided, or if maxCodeBlockGroupsPerTransportBlock is provided for serving cell c; else, set N_{TB,c}^{DL}=1; 4) set N_{HARQ-ACK,c}^{CBG/TB,max}, to the number of HARQ-ACK information bits per transport block (“TB”) for physical downlink shared channel (“PDSCH”) receptions on serving cell c if maxCodeBlockGroupsPerTransportBlock is provided for serving cell c and pdsch-HARQ-ACK-OneShotFeedbackCBG is provided; else, set N_{HARQ-ACK,c}^{CBG/TB,max}=0; 5) set NDI_{HARQ}=0 if pdsch-HARQ-ACK-OneShotFeedbackNDI is provided; else set NDI_{HARQ}=1; 6) set c=0-serving cell index; 7) set h=0-HARQ process number; 8) set t=0-TB index; 9) set g=0-CBG index; 10) set j=0, while c<N_{cells}^{DL}, while h<_{HARQ,c}^{DL}, if NDI_{HARQ}=0, if N_{HARQ-ACK,c}^{CBG/TB,max}>0, while t<N_{TB,c}^{DL}, while g<N_{HARQ-ACK,c}^{CBG/TB,max}, =HARQ-ACK information bit for CBG g of TB t for HARQ process number h of serving cell c, if any; else, õⱼ^{ACK}=0, j=j+1, g=g+1, end while, õⱼ^{ACK}=NDI value indicated in the DCI format corresponding to the HARQ-ACK information bit(s) for TB t for HARQ process number h on serving cell c, if any; else, õⱼ^{ACK}=0, g=0, j=j+1, t=t+1, end while, else, while t<N_{TB,c}^{DL}, õⱼ^{ACK}=HARQ-ACK information bit for TB t for HARQ process h of serving cell c, if any; else, õⱼ^{ACK}=0,j=j+1, õⱼ^{ACK}=NDI value indicated in the DCI format corresponding to the HARQ-ACK information bit(s) for TB t for HARQ process number h on serving cell c, if any; else, õⱼ^{ACK}=0, j=j+1, t=t+1, end while, end if, t=0, else, if N_{HARQ-ACK,c}^{CBG/TB,max}>0, while t<N_{TB,c}^{DL}> if UE has obtained HARQ-ACK information for TB t for HARQ process number h on serving cell c corresponding to a PDSCH reception and has not reported the HARQ-ACK information corresponding to the PDSCH reception, while g<N_{HARQ-ACK,c}^{CBG/TB,max}, õⱼ^{ACK}=HARQ-ACK information bit for CBG g of TB t for HARQ process number h of serving cell c, j=j+1, g=g+1, end while, else, while g<N_{HARQ-ACK,c}^{CBG/TB,max}, õⱼ^{ACK}=NACK, j=j+1, g=g+1, end while, end if, g=0, t=t+1, end while, else, while t<N_{TB,c}^{DL}, if UE has obtained HARQ-ACK information for TB t for HARQ process number h on serving cell c corresponding to a PDSCH reception and has not reported the HARQ-ACK information corresponding to the PDSCH reception, if harq-ACK-SpatialBundlingPUCCH is not provided, õⱼ^{ACK}=HARQ-ACK information bit for TB t for HARQ process h of serving cell c, else, õⱼ^{ACK}=binary AND operation of the HARQ-ACK information bits corresponding to first and second transport blocks for HARQ process h of serving cell c. If the UE receives one transport block, the UE assumes ACK for the second transport block, end if, j=j+1, t=t+1, else, õⱼ^{ACK}=NACK, j=j+1, t=t+1, end if, end while, end if, t=0, end if, h=h+1, end while, h=0, c=c+1, end while.

In some embodiments, if N_{TB,c}^{DL}>1, when a UE receives a PDSCH with one transport block, the HARQ-ACK information is associated with the first transport block.

In various embodiments, if a UE receives an SPS PDSCH, or a PDSCH that is scheduled by a DCI format that does not support CBG based PDSCH receptions for a serving cell c and if maxCodeBlockGroupsPerTransportBlock is provided for serving cell c, and pdsch-HARQ-ACK-OneShotFeedbackCBG is provided, the UE repeats N_{HARQ-ACK,c}^{CBG/TB,max} times the HARQ-ACK information for the transport block in the PDSCH.

In certain embodiments, if a UE detects a DCI format that includes a one-shot HARQ-ACK request field with value 1, the UE determines a PUCCH or a PUSCH to multiplex a Type-3 HARQ-ACK codebook for transmission in a slot. The UE multiplexes only the Type-3 HARQ-ACK codebook in the PUCCH or the PUSCH for transmission in the slot.

In some embodiments, if: 1) a UE detects a DCI format that includes a one-shot HARQ-ACK request field with value 1; and 2) the cyclic redundancy check (“CRC”) of the DCI is scrambled by a cell radio network temporary identifier (“RNTI”) (“C-RNTI”) or an modulation and coding scheme (“MCS”) C-RNTI (“MCS-C-RNTI”); and 3) resourceAllocation=resourceAllocationType0 and all bits of the frequency domain resource assignment field in the DCI format are equal to 0; or 4) resourceAllocation=resourceAllocationType1 and all bits of the frequency domain resource assignment field in the DCI format are equal to 1; or 5) resourceAllocation=dynamicSwitch and all bits of the frequency domain resource assignment field in the DCI format are equal to 0 or 1.

In various embodiments, a DCI format provides a request for a Type-3 HARQ-ACK codebook report and does not schedule a PDSCH reception. The UE is expected to provide HARQ-ACK information in response to the request for the Type-3 HARQ-ACK codebook after N symbols from the last symbol of a physical downlink control channel (“PDCCH”) providing the DCI format, where the value of N for μ=0,1,2 by replacing “SPS PDSCH release” with “DCI format.”

In certain embodiments, if a UE multiplexes HARQ-ACK information in a PUSCH transmission, the UE generates the HARQ-ACK codebook as described in this clause except that harq-ACK-SpatialBundlingPUCCH is replaced by harq-ACK-SpatialBundlingPUSCH.

In some embodiments, SL one shot HARQ feedback request and reporting may be performed by associating it with the source-destination pair, different cast type, and groupcast HARQ feedback options (e.g., option 1—common non-acknowledgement or negative acknowledgement (“NACK”) and option 2—dedicated ACK and/or NACK). In various embodiments, there may be requesting and/or reporting of one shot HARQ feedback considering all SL HARQ processes, subset of HARQ processes, and handling of inactive HARQ processes between the source-destination pair.

As described in FIG. 4, active SL HARQ processes between UE-1 402 and UE-3 406 are 2 and 6 while the active SL processes between UE-1 402 and UE-2 404 are 1 and 5. UE-1 402 may have 16 SL HARQ processes and may be shared with different RX UEs and/or destination IDs. The SL HARQ processes 1, 5 and other SL HARQ processes which are not in use between UE-1 402 and UE-3 406 remain as inactive SL HARQ processes between UE-1 402 and UE-3 406. However, these SL HARQ processes may be active between other RX UEs and/or destinations (e.g., between UE-1 402 and UE-2 404).

In certain embodiments, various vehicle to everything interface (“PC5”) containers may be used for transmitting one shot HARQ feedback reporting such as enhanced PSFCH format, 2nd SCI, medium access control (“MAC”) control element (“CE”), and so forth. In some embodiments, there may be DCI triggering of SL one shot HARQ feedback reporting.

In a first embodiment, there may be SL one shot HARQ feedback request and reporting by associating it with a source-destination pair, a different cast type, and groupcast HARQ feedback options (e.g., option 1—common NACK and option 2—dedicated ACK and/or NACK). In the first embodiment, one shot HARQ feedback report from Rx UE(s) may be requested by a transmit (“TX”) UE using a new field introduced in an SCI format 2A or any new second stage SCI format and, if the HARQ status (e.g., feedback status) is requested, a subset of HARQ processes that remain active between a pair of the Source Layer-2 ID and the Destination Layer-2 ID of UEs may be reported. The one shot HARQ feedback may be triggered as a request by the TX UE in the SCI corresponding to the pair of the Source Layer-2 ID and the Destination Layer-2 ID pair between the TX UE and a receive (“RX”) UE i.e., TX UE request a one-shot HARQ feedback for the HARQ processes associated with the pair of the Source ID and the Destination ID as indicated in the SCI. This request may be triggered due to various reasons such as delay in the reception of the HARQ-ACK report from the RX UE due to listen-before-talk (“LBT”) failures which may keep HARQ buffers and/or processes occupied at the TX UE.

In some embodiments, one shot HARQ feedback may be triggered as a request by a TX UE in the SCI associated with an L2 source-destination pair of the TX UE and the RX UE while the TX UE knows the L2 destination ID to cast type so that the TX UE can use the corresponding SCI format and/or set the cast type indicator in the SCI field for sending the one shot HARQ feedback request.

In some embodiments, transmitting ‘N’ SCI containing a one shot HARQ feedback request added to an SCI field corresponding to SL HARQ processes to each destination ID in a unicast, groupcast, or broadcast transmission may depend on a corresponding physical sidelink shared channel (“PSSCH”) cast type.

In various embodiments, one shot HARQ feedback may be triggered as a request by a TX UE in a new first stage or a second stage SCI containing one or more destination IDs. The TX UE may include a plurality of destination IDs associated with a PSSCH transmission corresponding to all SL HARQ processes (e.g., maximum SL HARQ processes is 16) to all supported cast types. The TX UE may transmit a one shot HARQ feedback request in a groupcast or broadcast transmission and may receive a plurality of one shot HARQ feedback reports from a plurality of destinations.

In a first option, one or more most significant bits (“MSBs”) may commonly represent a destination ID from a plurality of the destination IDs and may be included in one SCI field and/or one or more least significant bits (“LSBs”) representing each destination ID may be included in the SCI field. In another option, SCI may carry one shot HARQ feedback request, at least one destination id that may be related to the PSSCH reception, and some additional information such as a bitmap of active HARQ processes, a plurality of Source Layer-2 IDs, or a plurality of the Destination Layer-2 IDs that are associated with the SL HARQ processes may be carried in the MAC CE and the SCI and MAC CE may be transmitted together in the same slot. A TX UE may transmit SCI and MAC CE with no SL shared channel data (e.g., SL-SCH data) or SL-SCH data of at least the destination ID may be multiplexed with the MAC CE.

In a second option, a MAC layer may combine destination IDs in a group common destination ID and may signal the same in SCI, MAC CE, and/or semi-static RRC signaling.

In some embodiments, a UE may transmit one shot HARQ feedback request for those SL processes associated only to a one cast type (e.g., unicast) and may include a plurality of destination IDs corresponding to the unicast PSSCH.

In certain embodiments, a processing time for one shot HARQ feedback request (reception) and HARQ feedback report transmission timing from an RX UE to a TX UE may be separately configured (or preconfigured) per resource pool and it may be different compared to existing HARQ feedback timings: 1) in a first implementation of such embodiments, along with the one shot HARQ feedback request, some more information (e.g., such as a subset of HARQ process numbers as a bitmap or codebook index, etc.) may be transmitted by the TX UE-some of the codebook configurations may be exchanged using semi-static signaling such as PC5 radio resource control (“RRC”) signaling for unicast connection or may be configured (or preconfigured) per resource pool-if the TX UE knows an active process number between a source-destination pair of the TX UE and the RX UE from the received SCI, a HARQ feedback report is generated for those active HARQ process numbers considering an ascending order of the HARQ process number; 2) in a second implementation of such embodiments, the RX UE may autonomously choose the subset of HARQ processes or codebook for which HARQ feedback information will be transmitted in the one shot HARQ feedback report—the HARQ process number or the selected codebook may be signaled as part of the one shot HARQ feedback report—in some embodiments, if the TX UE may know the active process number between the source-destination pair of the TX UE and the RX UE, a HARQ feedback report is generated for those active HARQ process numbers considering the ascending order of the HARQ process number and the HARQ process number may not be signaled as part of the HARQ feedback report; and/or 3) in a third implementation of such embodiments, the RX UE may transmit the one shot HARQ feedback report containing all HARQ processes, whereas the TX UE may ignore a HARQ feedback report corresponding to those inactive HARQ process numbers (e.g., assuming that only a subset of HARQ processes may remain active between the source-destination pair of the TX UE and the RX UE which is known at the Tx UE side), while the RX UE may report a default value such as a discontinuous transmission (“DTX”), NACK, or ACK corresponding to those inactive HARQ process numbers and/or default NDI value corresponding to those inactive HARQ process number in the one shot HARQ feedback report.

In various embodiments, one shot HARQ feedback may be triggered as a request by a TX UE in SCI associated with a source-destination pair of the TX UE and the RX UE which may be for a unicast, groupcast, and/or broadcast transmission and/or reception and a HARQ feedback report may be generated depending on the unicast and/or HARQ groupcast option 1 and/or HARQ groupcast option 2 associated with those destination IDs and their HARQ process numbers: 1) in a first implementation of such embodiments, then the TX UE separately transmits a one shot HARQ feedback request associated with a cast type of a PSSCH transmission corresponding to destination IDs which may results in the transmission of one shot HARQ feedback request separately for unicast and/or groupcast transmission; and/or 2) in a second implementation of such embodiments, the TX UE chooses a groupcast SCI format and/or cast type indicator in an SCI field set to groupcast and/or a cast type indicator in the SCI field set to undefined to transmit a one shot HARQ feedback request for those destination IDs associated with the unicast and/or groupcast transmissions. The RX UEs may generate a HARQ feedback report corresponding to the destination IDs and their HARQ process numbers according to rules for corresponding cast types.

In certain embodiments, for one-shot HARQ feedback, if a new data indicator (“NDI”) is be configured to be part of one-shot HARQ feedback reporting, then the latest NDI value detected by a UE is reported along with HARQ-ACK for the corresponding HARQ process ID. The UE may assume an NDI-0 if there is no prior NDI value for the HARQ process and an NDI is included for each TB. When the NDI is not configured, then the NDI value is not reported along with HARQ-ACK for the corresponding PSSCH or for that source-destination pair. The TX UE and/or RX UE after reporting the one shot HARQ feedback report to the gNB and the TX UE respectively may be expected to reset a HARQ-ACK state (e.g., as DTX or NACK or ACK as specified in the resource pool or preconfigured by the gNB) for a HARQ process ID once ACK is reported for the same HARQ process ID in the previous feedback. For any HARQ ID that is scheduled after the last determined PSSCH for which HARQ-ACK/NACK decoding result is reported, the UE does not consider this PSSCH for one-shot HARQ codebook composition.

In some embodiments, in a one-shot codebook, an NDI follows the HARQ-ACK information for each TB and the ordering of information for HARQ-ACK and NDI are as follows: 1) TB index; and 2) HARQ process ID.

In various embodiments, a one-shot codebook may be structured considering different cast types: unicast, groupcast (e.g., HARQ feedback option 1 and/or HARQ feedback option 2), and broadcast. Then blind transmissions (or retransmissions) may be made.

In certain embodiments, if one or more RX UEs, after receiving a one shot HARQ feedback request from a TX UE in SCI associated with a source-destination pair of the TX UE and RX UE which may be for a unicast transmission, a HARQ feedback report is generated containing ACK or NACK for those associated HARQ process numbers.

In some embodiments, one shot HARQ feedback may be triggered as a request by a TX UE in SCI associated with a source-destination pair of the TX UE and an RX UE which may be for a groupcast transmission and a HARQ feedback report may be generated depending on a HARQ groupcast option 1 and/or HARQ groupcast option 2 associated with HARQ process numbers.

In various embodiments, one or more RX UEs, after receiving one shot HARQ feedback request from a TX UE in the SCI associated with a source-destination pair of the TX UE and the RX UE which may be for a groupcast transmission, and, if the HARQ feedback is to be generated for HARQ groupcast feedback option 1 associated with those HARQ process numbers, then those RX UEs that did not decode the transport block may generate and transmit a one shot HARQ feedback report. A minimum communication range (“MCR”) value may be signaled as part of the SCI which may be a highest MCR value or latest MCR value for that HARQ process number and/or TB transmission or configured (or preconfigured) per resource pool. The TX UE may not receive one shot HARQ feedback from those RX UEs within a signaled MCR that successfully decodes a TB. The TX UE may report to higher layers an ACK value if the TX UE determines absence of one shot HARQ feedback reception from one or more RX UEs; otherwise, it may report a NACK value to higher layers.

In certain embodiments, RX UEs may generate a HARQ feedback report containing ACK or NACK for those associated HARQ process numbers corresponding to the decoding status of the TB.

In some embodiments, one or more RX UEs, after receiving a one shot HARQ feedback request from a TX UE in SCI associated with a source-destination pair of the TX UE and the RX UE which may be for a groupcast transmission, and, if the HARQ feedback is to be generated for HARQ groupcast feedback option 2 associated with those HARQ process numbers, then the RX UEs may generate a HARQ feedback report containing ACK or NACK for those associated HARQ process numbers corresponding to the decoding status of the TB.

In various embodiments, one shot HARQ feedback may be triggered as a request by a TX UE in SCI associated with a source-destination pair of the TX UE and the RX UE which may be for a broadcast or blind transmission (or retransmission) and a HARQ feedback report is generated and contains a default value such as a DTX or NACK for those associated HARQ process numbers. In certain embodiments, a HARQ feedback report is generated containing a latest decoding status of a PSSCH transmission containing ACK or NACK associated for those HARQ processes.

In some embodiments, a one shot HARQ feedback may be triggered as a request by a TX UE only for a unicast transmission, or only corresponding to those HARQ process numbers associated with the unicast transmission and/or reception other HARQ process numbers associated with groupcast transmission may report a default value such as a DTX, NACK, or ACK.

In certain embodiments, priority of a one shot HARQ feedback request and/or report may take the highest priority among the PSSCH priorities, which includes the PSSCH transmitted together with the request and/or report. In some embodiments, a priority of a one shot HARQ feedback request and/or report may be preconfigured in a resource pool or transmitted to a UE. In various embodiments, a priority of a one shot HARQ feedback report and/or request may take a highest priority among active SL HARQ processes transmitting PSSCH.

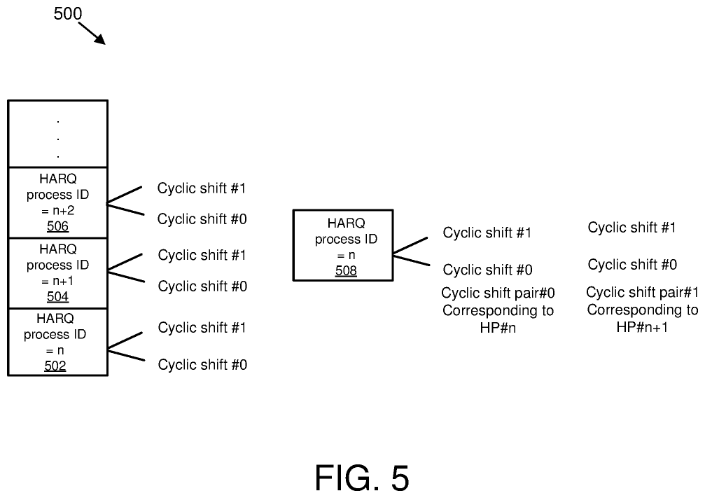

In a second embodiment, there may be PC5 containers for transmitting one shot HARQ feedback reports. In the second embodiment, there may be various implementation options for the PC5 container carrying the one-shot HARQ feedback report as follows: 1) in a first implementation option, there may be a new PSFCH format associated with one-shot HARQ feedback reporting where a resource for the new PSFCH format may be frequency division multiplexed (“FDMed”) and/or time division multiplexed (“TDMed”) with that of the existing PSFCH format configured (or preconfigured) in a resource pool; 2) in a second option, the existing PSFCH format design is enhanced such that each HARQ process is allocated according to an ascending order of a physical resource block (“PRB”) index and then a cyclic shift from a cyclic shift pair corresponding to ACK and NACK is applied as shown in FIG. 5; 3) in a third option, the existing PSFCH format design is enhanced such that each cyclic shift pair is allocated according to each HARQ process, then cyclic shift from the cyclic shift pair corresponding to ACK and NACK is applied as shown in FIG. 5; 4) in a fourth option, the existing PSFCH format design is enhanced such that each HARQ process is allocated according to the ascending order of the PRB index and then each cyclic shift pair is allocated according to each group member UE, then cyclic shift from the cyclic shift pair corresponding to ACK and NACK is applied; 5) in a fifth option, an RX UE may piggyback one shot HARQ feedback report in PSSCH and a beta factor may be transmitted in SCI; 6) in a sixth option, a 2nd SCI format may be defined carrying the one shot HARQ feedback report; and/or 7) in another option, a MAC CE may carry the one shot HARQ feedback report, maximum allowed latency for transmitting the MAC CE, and a priority of the MAC CE may be configured (or preconfigured). A separate SR may be configured to request a resource for the transmission of the MAC CE carrying the SL HARQ feedback report. A timer maybe started once the one shot HARQ feedback request is received by the RX UE(s) and the timer may be stopped after the transmission of the SL HARQ feedback report. If the timer expires and the SL HARQ feedback report could not be transmitted, then the SL HARQ feedback report may be dropped.

FIG. 5 is a schematic block diagram illustrating one embodiment of a system 500 for PSFCH enhancement for reporting one shot HARQ feedback. The system 500 includes a first HARQ process ID=n 502, a HARQ process ID=n+1 504, a HARQ process ID=n+2 506, and a second HARQ process ID=n 508.

In a third embodiment, there may be DCI triggering one shot HARQ feedback. In some embodiments, a TX UE may be requested to report one shot HARQ feedback by a gNB using a bit field in a DCI format 3_0. The TX UE may perform remapping of a SL HARQ process number while reporting it to the gNB as the TX UE may autonomously select a SL HARQ process number for PSSCH transmission.

In various embodiments, a minimum time gap between a one shot HARQ feedback request transmitted in a SL grant and transmission of a HARQ feedback report may be indicated using DCI. A PUCCH resource may be indicated in a DCI format 3_0 using PSFCH to PUCCH feedback timing and a PUCCH resource indicator (“PRI”). In certain embodiments, a non-numerical PSFCH to PUCCH feedback timing value may be indicated in a DCI format 3_0 along with a one shot HARQ feedback request and actual feedback timing may be indicated in a separate DCI trigger using the PSFCH to PUCCH feedback timing. If the one shot HARQ feedback is requested using DCI format 3_0, then a scheduling SL grant for the PSSCH transmission in the same DCI format 3_0 may be optional, which may mean it is not necessary to provide a SL grant for PSSCH transmission if one shot HARQ feedback is requested.

In some embodiments, a one shot HARQ feedback may be triggered by a TX UE using SCI based on a corresponding one shot HARQ feedback request received in a SL grant using DCI format 3_0. If one-shot feedback is requested by a gNB using DCI, the TX UE may trigger one or more one short feedback requests to one or more RX UEs and/or destination IDs.

In various embodiments, a one shot HARQ feedback may be generated by a TX UE for all SL HARQ processes and the TX UE may, for a broadcast, blind transmission (or retransmission), inactive HARQ process, transmission using mode 2, generate a HARQ feedback report containing a default value such as DTX, NACK, or ACK for associated HARQ process numbers.

In certain embodiments, a one shot HARQ feedback report may be generated by a TX UE only for a subset of SL HARQ processes scheduled using a mode 1 grant. In some embodiments, a TX UE reports all SL HARQ processes and generates a default value such as DTX, NACK, or ACK for those SL HARQ processes transmitted with blind retransmission, mode 2 resource allocation, and/or broadcast. In certain embodiments, default HARQ feedback values may be preconfigured in a resource pool and/or signaled using a semi-static common signaling or semi-static dedicates signaling.

In various embodiments, one shot HARQ feedback reporting from a plurality of SL carriers may be configured. In certain embodiments, a one shot HARQ feedback request from a transmitter UE corresponding to all SL HARQ processes may be requested considering to a plurality of SL carriers.

In certain embodiments, for one-shot HARQ feedback, if NDI is configured to be part of one-shot HARQ feedback reporting, then a latest NDI value detected by a UE is reported along with HARQ-ACK for the corresponding HARQ process ID. In some embodiments, in a one-shot codebook, NDI follows HARQ-ACK information for each TB and ordering of information for HARQ-ACK and NDI may be as follows: 1) TB index; 2) HARQ process ID; and/or 3) SL carrier index.

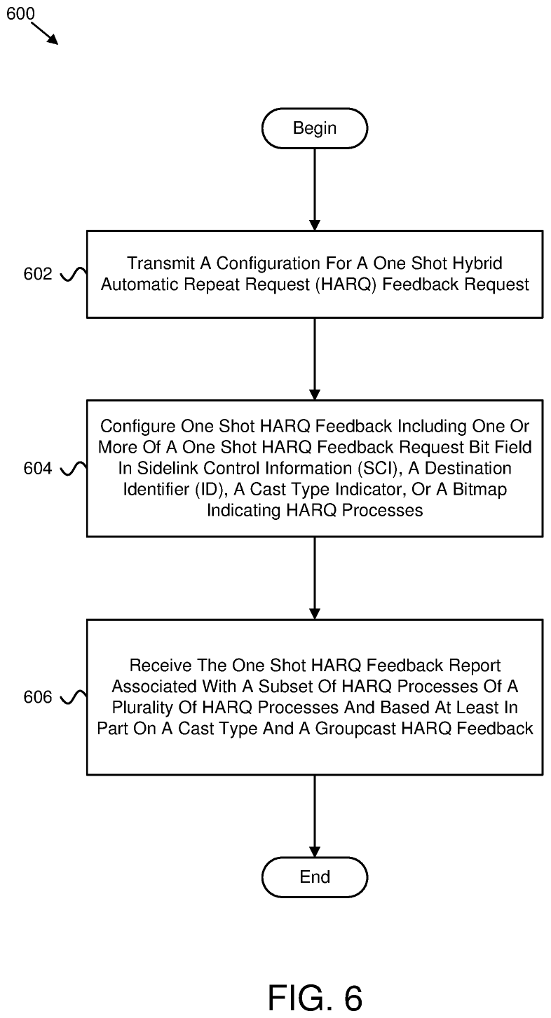

FIG. 6 is a flow chart diagram illustrating one embodiment of a method 600 for one shot HARQ feedback reporting. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes transmitting 602, from a UE, a configuration for a one shot HARQ feedback request to at least one receiver. In some embodiments, the method 600 includes configuring 604 one shot HARQ feedback including one or more of a one shot HARQ feedback request bit field in sidelink control information (“SCI”), a destination identifier (“ID”), a cast type indicator, or a bitmap containing HARQ processes. In certain embodiments, the method 600 includes receiving 606 the one shot HARQ feedback report associated with a subset of HARQ processes of a plurality of HARQ processes and based at least in part on a cast type and a groupcast HARQ feedback.

In certain embodiments, the method 600 further comprises transmitting a SL one shot HARQ feedback request transmission using a second SCI format containing at least one destination ID in a unicast, groupcast, or broadcast transmission. In some embodiments, the method 600 further comprises transmitting a quantity of SCI containing one shot HARQ feedback request to each device associated with each respective destination ID in a unicast or groupcast or broadcast transmission depending on a corresponding PSSCH cast type. In various embodiments, the method 600 further comprises requesting a reporting of one shot HARQ feedback corresponding to all SL HARQ processes, a subset of HARQ processes, and handling of inactive HARQ processes between a pair of devices.

In one embodiment, the method 600 further comprises receiving a default HARQ feedback for inactive HARQ processes as part of the one shot HARQ feedback report. In certain embodiments, the method 600 further comprises ignoring the HARQ feedback for inactive HARQ processes in the one shot HARQ feedback report.

In some embodiments, the one shot HARQ feedback report corresponds to a V2X container. In various embodiments, the V2X containers comprise an enhanced PSFCH format, a second SCI, a MAC CE, or a combination thereof.

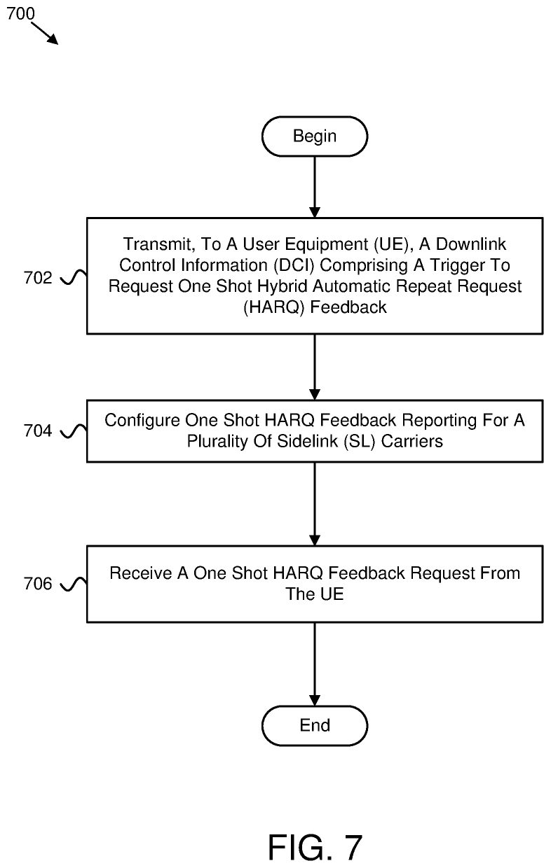

FIG. 7 is a flow chart diagram illustrating another embodiment of a method 700 for one shot HARQ feedback reporting. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes transmitting 702, from a network device to a UE, a DCI comprising a trigger to request one shot HARQ feedback. In some embodiments, the method 700 includes configuring 704 one shot HARQ feedback reporting for a plurality of SL carriers. In certain embodiments, the method 700 includes receiving 706 a one shot HARQ feedback request from the UE.

In certain embodiments, the trigger is transmitted based on a numerical feedback timing value. In some embodiments, the trigger is transmitted based on a non-numerical feedback timing value.

In various embodiments, the method 700 further comprises receiving HARQ feedback from the UE for a subset of HARQ processes associated with a mode 1 grant. In one embodiment, the method 700 further comprises ignoring HARQ feedback from the UE for a subset HARQ processes associated with mode 2 transmission of data, broadcast transmission of data, or blind retransmission of data.

In one embodiment, a method includes: transmitting a configuration for a one shot HARQ feedback request; configuring one shot HARQ feedback including one or more of a one shot HARQ feedback request bit field in SCI, a destination ID, a cast type indicator, or a bitmap indicating HARQ processes; and receiving the one shot HARQ feedback report associated with a subset of HARQ processes of a plurality of HARQ processes and based at least in part on a cast type and a groupcast HARQ feedback.

In certain embodiments, the method further comprises transmitting a SL one shot HARQ feedback request transmission using a second SCI format containing at least one destination ID in a unicast, groupcast, or broadcast transmission.

In some embodiments, the method further comprises transmitting a quantity of SCI containing one shot HARQ feedback request to each device associated with each respective destination ID in a unicast or groupcast or broadcast transmission depending on a corresponding PSSCH cast type.

In various embodiments, the method further comprises requesting a reporting of one shot HARQ feedback corresponding to all SL HARQ processes, a subset of HARQ processes, and handling of inactive HARQ processes between a pair of devices.

In one embodiment, the method further comprises receiving a default HARQ feedback for inactive HARQ processes as part of the one shot HARQ feedback report.

In certain embodiments, the method further comprises ignoring the HARQ feedback for inactive HARQ processes in the one shot HARQ feedback report.

In some embodiments, the one shot HARQ feedback report corresponds to a V2X container.

In various embodiments, the V2X containers comprise an enhanced PSFCH format, a second SCI, a MAC CE, or a combination thereof.

In one embodiment, an apparatus includes: a processor; and a memory coupled to the processor, the processor configured to cause the apparatus to: transmit a configuration for a one shot HARQ feedback request; configure one shot HARQ feedback including one or more of a one shot HARQ feedback request bit field in SCI, a destination ID, a cast type indicator, or a bitmap indicating HARQ processes; and receive the one shot HARQ feedback report associated with a subset of HARQ processes of a plurality of HARQ processes and based at least in part on a cast type and a groupcast HARQ feedback.

In certain embodiments, the processor is configured to cause the apparatus to transmit a SL one shot HARQ feedback request transmission using a second SCI format containing at least one destination ID in a unicast, groupcast, or broadcast transmission.

In some embodiments, the processor is configured to cause the apparatus to transmit a quantity of SCI containing one shot HARQ feedback request to each device associated with each respective destination ID in a unicast or groupcast or broadcast transmission depending on a corresponding PSSCH cast type.

In various embodiments, the processor is configured to cause the apparatus to request a reporting of one shot HARQ feedback corresponding to all SL HARQ processes, a subset of HARQ processes, and handling of inactive HARQ processes between a pair of devices.

In one embodiment, the processor is configured to cause the apparatus to transmit a default HARQ feedback for inactive HARQ processes as part of the one shot HARQ feedback report.

In certain embodiments, the processor is configured to cause the apparatus to ignore the HARQ feedback for inactive HARQ processes in the one shot HARQ feedback report.

In some embodiments, the one shot HARQ feedback report corresponds to a V2X container.

In various embodiments, the V2X containers comprise an enhanced PSFCH format, a second SCI, a MAC CE, or a combination thereof.

In one embodiment, a method of a network device comprises: transmitting, to a UE, a DCI comprising a trigger to request one shot HARQ feedback; configuring one shot HARQ feedback reporting for a plurality of SL carriers; and receiving a one shot HARQ feedback request from the UE.

In certain embodiments, the trigger is transmitted based on a numerical feedback timing value.

In some embodiments, the trigger is transmitted based on a non-numerical feedback timing value.

In various embodiments, the method further comprises receiving HARQ feedback from the UE for a subset of HARQ processes associated with a mode 1 grant.

In one embodiment, the method further comprises ignoring HARQ feedback from the UE for a subset HARQ processes associated with mode 2 transmission of data, broadcast transmission of data, or blind retransmission of data.

In one embodiment, an apparatus comprises: a processor; and a memory coupled to the processor, the processor configured to cause the apparatus to: transmit, to a UE, a DCI comprising a trigger to request one shot HARQ feedback; configure one shot HARQ feedback reporting for a plurality of SL carriers; and receive a one shot HARQ feedback request from the UE.

In certain embodiments, the trigger is transmitted based on a numerical feedback timing value.

In some embodiments, the trigger is transmitted based on a non-numerical feedback timing value.

In various embodiments, the processor is configured to cause the apparatus to receive HARQ feedback from the UE for a subset of HARQ processes associated with a mode 1 grant.

In one embodiment, the processor is configured to cause the apparatus to ignore HARQ feedback from the UE for a subset HARQ processes associated with mode 2 transmission of data, broadcast transmission of data, or blind retransmission of data.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a user equipment (UE), the method comprising:
transmitting a configuration for a one shot hybrid automatic repeat request (HARQ) feedback request;
configuring one shot HARQ feedback including one or more of a one shot HARQ feedback request bit field in sidelink control information (SCI), a destination identifier (ID), a cast type indicator, or a bitmap indicating HARQ processes; and
receiving the one shot HARQ feedback report associated with a subset of HARQ processes of a plurality of HARQ processes and based at least in part on a cast type and a groupcast HARQ feedback.

2. The method of claim 1, further comprising transmitting a sidelink (SL) one shot HARQ feedback request transmission using a second SCI format containing at least one destination ID in a unicast, groupcast, or broadcast transmission.

3. The method of claim 2, further comprising transmitting a quantity of SCI containing one shot HARQ feedback request to each device associated with each respective destination ID in a unicast or groupcast or broadcast transmission depending on a corresponding physical sidelink shared channel (PSSCH) cast type.

4. The method of claim 1, further comprising requesting a reporting of one shot HARQ feedback corresponding to all SL HARQ processes, a subset of HARQ processes, and handling of inactive HARQ processes between a pair of devices.

5. The method of claim 1, further comprising receiving a default HARQ feedback for inactive HARQ processes as part of the one shot HARQ feedback report.

6. The method of claim 1, further comprising ignoring the HARQ feedback for inactive HARQ processes in the one shot HARQ feedback report.

7. A user equipment (UE), comprising:
at least one memory; and
at least one processor coupled with the at least one memory and configured to cause the UE to:
transmit a configuration for a one shot hybrid automatic repeat request (HARQ) feedback request;
configure one shot HARQ feedback including one or more of a one shot HARQ feedback request bit field in sidelink control information (SCI), a destination identifier (ID), a cast type indicator, or a bitmap indicating HARQ processes; and
receive the one shot HARQ feedback report associated with a subset of HARQ processes of a plurality of HARQ processes and based at least in part on a cast type and a groupcast HARQ feedback.

8. The UE of claim 7, wherein the at least one processor is configured to cause the UE to transmit a sidelink (SL) one shot HARQ feedback request transmission using a second SCI format containing at least one destination ID in a unicast, groupcast, or broadcast transmission.

9. The UE of claim 8, wherein the at least one processor is configured to cause the UE to transmit a quantity of SCI containing one shot HARQ feedback request to each device associated with each respective destination ID in a unicast or groupcast or broadcast transmission depending on a corresponding physical sidelink shared channel (PSSCH) cast type.

10. The UE of claim 7, wherein the at least one processor is configured to cause the UE to request a reporting of one shot HARQ feedback corresponding to all SL HARQ processes, a subset of HARQ processes, and handling of inactive HARQ processes between a pair of devices.

11. The UE of claim 7, wherein the at least one processor is configured to cause the UE to transmit a default HARQ feedback for inactive HARQ processes as part of the one shot HARQ feedback report.

12. The UE of claim 7, wherein the at least one processor is configured to cause the UE to ignore the HARQ feedback for inactive HARQ processes in the one shot HARQ feedback report.

13. The UE of claim 7, wherein the one shot HARQ feedback report corresponds to a vehicle-to-everything (V2X) container.

14. The UE of claim 13, wherein the V2X containers comprise an enhanced physical sidelink feedback channel (PSFCH) format, a second SCI, a medium access control (MAC) control element (CE), or a combination thereof.

15. An apparatus for performing a network function, the apparatus comprising:
at least one memory; and
at least one processor coupled with the at least one memory and configured to cause the apparatus to:
transmit, to a user equipment (UE), a downlink control information (DCI) comprising a trigger to request one shot hybrid automatic repeat request (HARQ) feedback;
configure one shot HARQ feedback reporting for a plurality of sidelink (SL) carriers; and
receive a one shot HARQ feedback request from the UE.

16. A processor for wireless communication, comprising:
at least one controller coupled with at least one memory and configured to cause the processor to:
transmit a configuration for a one shot hybrid automatic repeat request (HARQ) feedback request;
configure one shot HARQ feedback including one or more of a one shot HARQ feedback request bit field in sidelink control information (SCI), a destination identifier (ID), a cast type indicator, or a bitmap indicating HARQ processes; and
receive the one shot HARQ feedback report associated with a subset of HARQ processes of a plurality of HARQ processes and based at least in part on a cast type and a groupcast HARQ feedback.

17. The processor of claim 16, wherein the at least one controller is configured to cause the processor to transmit a sidelink (SL) one shot HARQ feedback request transmission using a second SCI format containing at least one destination ID in a unicast, groupcast, or broadcast transmission.

18. The processor of claim 17, wherein the at least one controller is configured to cause the processor to transmit a quantity of SCI containing one shot HARQ feedback request to each device associated with each respective destination ID in a unicast or groupcast or broadcast transmission depending on a corresponding physical sidelink shared channel (PSSCH) cast type.

19. The processor of claim 16, wherein the at least one controller is configured to cause the processor to request a reporting of one shot HARQ feedback corresponding to all SL HARQ processes, a subset of HARQ processes, and handling of inactive HARQ processes between a pair of devices.

20. The processor of claim 16, wherein the at least one controller is configured to cause the processor to transmit a default HARQ feedback for inactive HARQ processes as part of the one shot HARQ feedback report.
